(19) United States
(12) Patent Application Publication
(10) Pub. No.: US 2002/0121745 A1
(43) Pub. Date: Sep. 5, 2002

(54) Outlet device with an intraseal for a pressurized vessel

(76) Inventors: Keith Vogel, Queensbury, NY (US); John D. Weston, Queensbury, NY (US); John F. Bolles, Queensbury, NY (US)

Correspondence Address: NIXON & VANDERHYE P.C., 8th Floor, 1100 North Glebe Road, Arlington, VA, 22201, US

(21) Appl. No.: 10/073,265

(22) Filed: Feb. 13, 2002

Related U.S. Application Data
(60) Provisional application No. 60/272,040, filed on Mar. 1, 2001.

(51) Int. Cl. F16J 15/18

(52) U.S. Cl. 277/510

(57) ABSTRACT

A shaft outlet assembly for a digester is disclosed that includes: a rotatable shaft extending from the outlet assembly into a pressurized of the digester; a pack box mounted on the digester and having packing around the shaft, and a sealing ring mounted on a movable assembly inside of the pressure vessel, the sealing ring encircling the shaft, said movable assembly having a first position providing a nominal clearance between the sealing ring and shaft, and a second position at which the sealing ring is against the shaft and pack box to provide a substantially fluid-tight seal between said pack box and the shaft.

### RELATED APPLICATION

Priority is claimed to U.S. Provisional patent application Ser. No. 60/272,040, filed Mar. 1, 2001, the entirety of which application is incorporated by reference herein.

### BACKGROUND AND SUMMARY OF THE INVENTION

In the Pulp and Paper industry, as well as in other Process Industries, chemical reactions are often performed under pressures greater than atmospheric pressure. Typically, these reactions are performed within vessels which are specially designed to retain the pressures, and also the temperatures, required for the reaction, for example chemical reactors or pulp digesters. The processes performed, either batch or continuous, often require some form of agitation or stirring during the process. This agitation is typically effected by some form of shaft-driven agitator which is typically powered by an electric motor via some form of power transfer device, for example, belts, drive chains, or a gear reducer.

The drive shaft of the agitator penetrates the wall of pressure vessel. Thus, some form of structural support, e.g., a seal, must be provided to maintain the integrity of the vessel wall where it has been penetrated by the drive shaft. Some form of seal must also be provided to prevent the pressurized, typically heated, sometimes harmful, contents of the vessel from escaping out the clearance between the typically cylindrical shaft and the opening in the vessel. Also, some form of bearing is typically provided to reduce friction between the rotating or reciprocating shaft and the support housing. Typically, the bearings used are roller bearings, for example, spherical or cylindrical anti-friction bearings, or a journal-type bearing which is self-lubricating or has reduced-friction properties.

The seal that prevents pressurized fluids from escaping around the rotating drive shaft is typically provided by a rope-type fabric, or “packing”, or elastomeric seal ring, or some form of “mechanical” sealing arrangement. For example, the packing is typically installed in a stationary cavity or “packing box” or “pack box” that surrounds the shaft and is retained by a retaining ring or “gland follower”. The rotating shaft bears against the stationary packing and the packing prevents the contents of the vessel from escaping. Typically, to reduce the wear rate of the softer packing some form of wear-resistant material is incorporated into the packing. For example, the packing may include a polytetraflouroethylene(PTFE)-containing material, or graphite, for example, Dupont's Teflon® material.

The packing is subject to wear and tear. Typically, the packing is inspected and replaced at regular intervals to avoid having fluids flowing through the digester to leak through the packing. In the prior art, replacing the packing material requires that the seal between the digester and the drive shaft be opened to provide access to the packing material. In the past, replacing the packing has generally required that the digester to be stopped, depressurized and drained of its fibrous slurry. As is often the case, to prevent personnel or property damage when such hardware is serviced, the digester vessel slurry contents must be removed so that these fluid contents do not flow out of the digester at the drive shaft while the packing material is being replace. For small pressure vessels, draining the slurry is not as inconvenient as for large vessels. For example, in a large pressure vessel of a pulp digester, the cost of time and lost production due to draining the slurry can be substantial. For example, at one pulp mill the cost of emptying a continuous pulping digester in order to replace packings is about a million U.S. dollars.

The present invention provides a method and apparatus for servicing and replacing the packing seal for a drive shaft of an agitator in a digester, which eliminates the need for evacuating the digester vessel prior to servicing. A feature of the present invention is an auxiliary sealing mechanism that is dormant during normal digester operation, e.g., while the shaft is rotating. This auxiliary sealing mechanism is applied to seal the gap between a stationary drive shaft and drive shaft bearing of the digester while the packing material is being inspected and replaced. The auxiliary sealing mechanism avoids having to drain the digester of pressurized fluid in order to replace the packing material.

One aspect of the present invention is an apparatus, e.g., movable ring seal, for preventing fluid leakage from a vessel having a shaft penetrating the vessel during servicing of the shaft packing materials. The present invention to provide a mechanism and method of being able to service packings, without requiring the vessel to be emptied of its contents. These and other aspects of the invention will become clear from the detailed description of the invention, and from the appended claims.

The invention, in an exemplary embodiment, is an intra-seal pack box for a diluting or non-diluting digester outlet device, or other pressure vessel. The pack box is mounted at the bottom of a digester and around the drive shaft for the outlet device. The pack box includes a top plate inside of the digester vessel that is normally held in an up and non-functioning position. The top plate is an auxiliary sealing device that provides a seal in substitution for the packing material, when that material is being replaced. To replace the packing material, the plate is moved downward to form a seal between the outlet device bottom cover housing and the shaft.

The plate may include a sealing ring having triangular surfaces that bear against opposing surfaces of the housing and the shaft. The pressure of the fluid in the digester would facilitate the seal by applying a pressure force on the sealing ring to seal the ring against the housing and shaft. The plate may be mounted on guide rods having screws that can be turned from outside of the digester vessel to move the plate up and out of sealing position, and down and into sealing position.

Gland passages in the housing and near the top plate provide water passages that are used to direct water to flush the surfaces of the housing and shaft that engage the sealing ring. The water flush is applied during operation and just prior to moving the top plate into position. In addition, the fluid pressure in these passages may be monitored to confirm that a good seal exists, after the sealing plate is moved into its sealing position.

In one embodiment the invention is a shaft outlet assembly for a digester, comprising: a rotatable shaft extending from the outlet assembly into a pressurized vessel of the digester; a pack box mounted on the vessel and having packing around the shaft, and a sealing ring mounted on a plate inside of the pressure vessel, the sealing ring encircling the shaft and having a nominal clearance with the pack box, said plate moveable with respect to the pressure vessel to move the sealing ring against the shaft to provide a substantially fluid-tight seal between said ring and the shaft.

In another embodiment the invention is a method for servicing packing material in a shaft outlet assembly of a digester, wherein the assembly includes a plate with a sealing ring in a pressure vessel of the digester and said ring extends around a shaft extending into the pressure vessel of the digester and a pack box, said method comprising the steps of: providing a fluid-tight seal between the shaft and pressure vessel with packing of the pack box; in order to service the packing, moving the plate so as to press the sealing ring against the shaft and create a fluid-tight seal between the sealing ring and shaft; refurbishing the packing material while maintaining a slurry in the digester under pressure using the seal formed by the sealing ring; moving the shaft so as to move the sealing ring out of the fluid-tight seal with the shaft such that the packing material forms a seal between the pack box and shaft, and rotating the shaft during operation of the digester, wherein the rotating shaft is sealed by the pack box and the sealing ring is separated from the pack box.

### BRIEF DESCRIPTION OF AN EMBODIMENT OF THE INVENTION

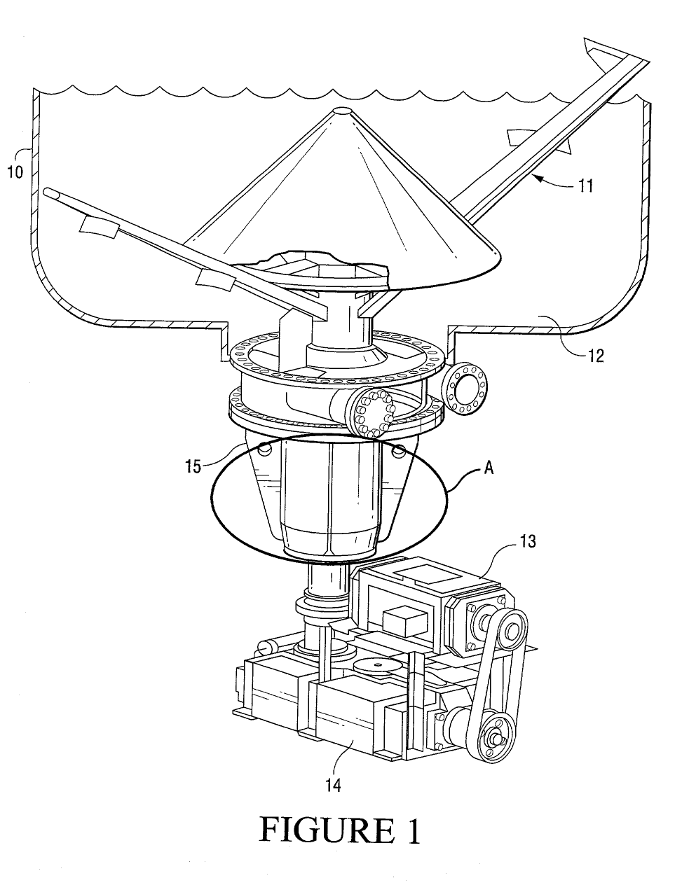

FIG. 1 is a partial perspective view, with portions of the vessel cut away for clarity of illustration, of a conventional prior art vessel with shaft, and shaft operating and supporting components;

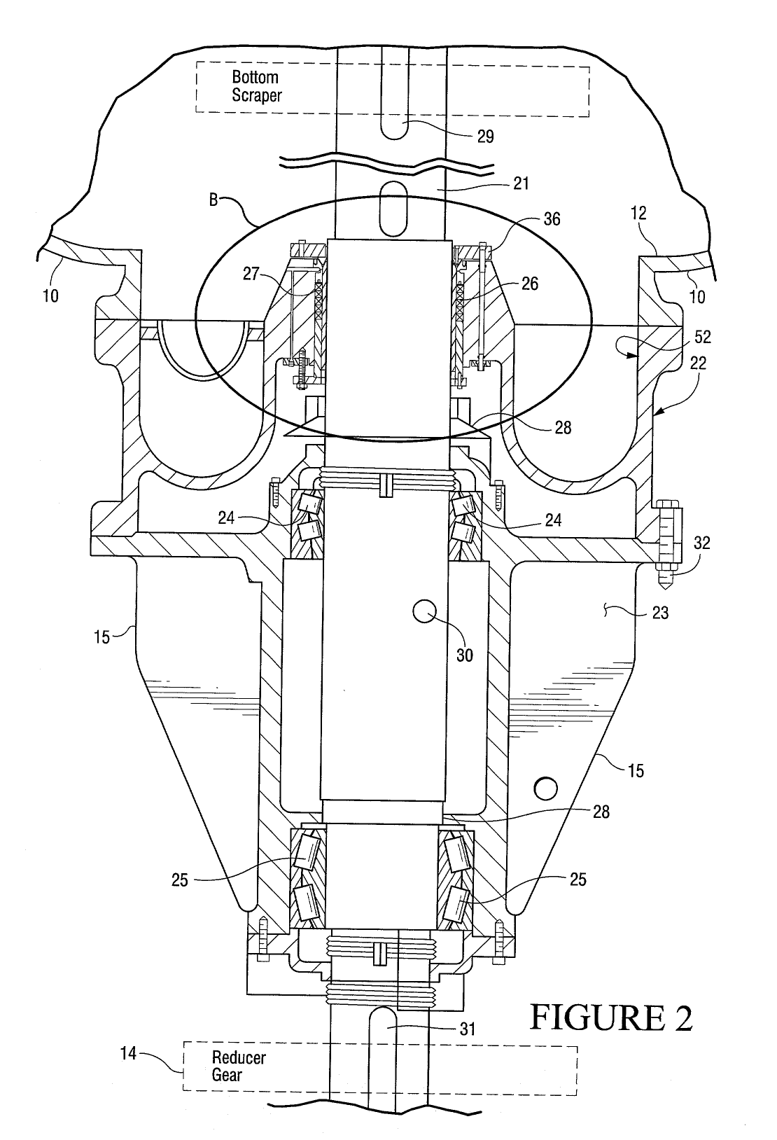

FIG. 2 is a detailed side view, partly in cross-section and partly in elevation, of the area A of FIG. 1, showing a shaft, and vessel where it interfaces the shaft, of the structure of FIG. 1;

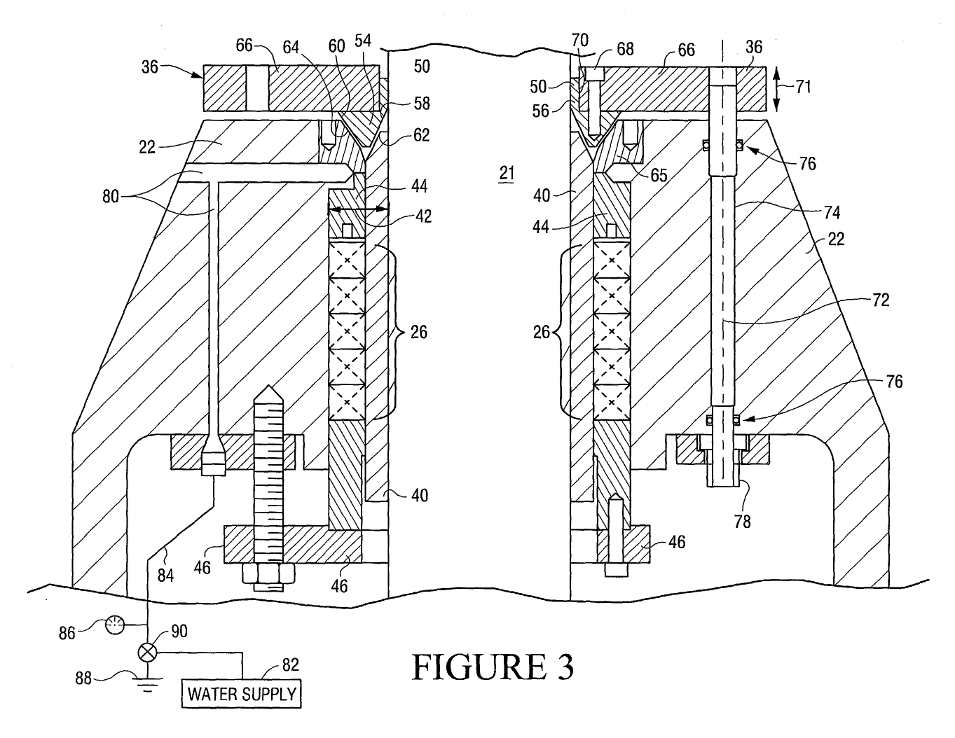

FIG. 3 is a detail side view of the area B of FIG. 2, partly in cross section and partly in elevation, of an exemplary embodiment of the packings and auxiliary sealing mechanism; and

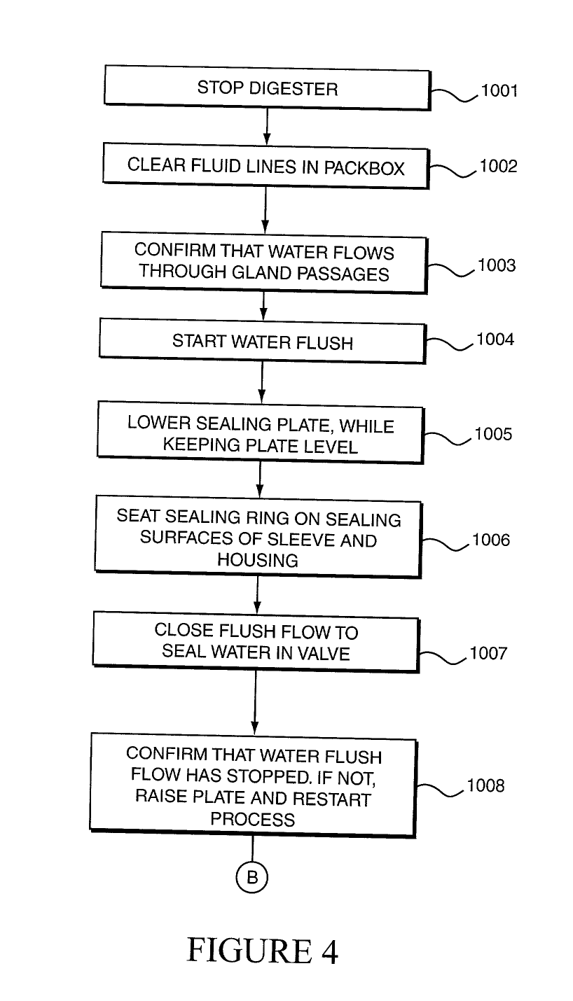

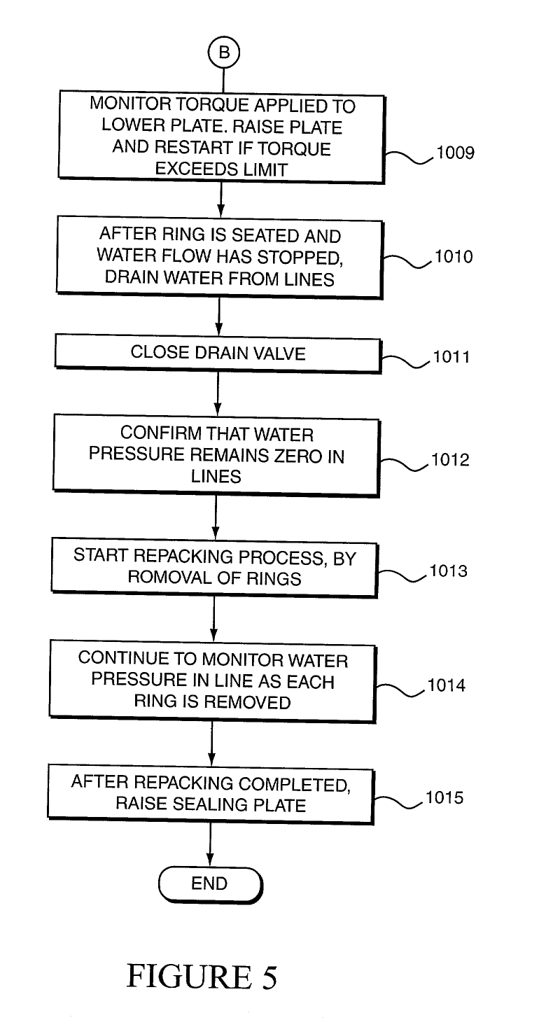

FIGS. 4 and 5 are flow charts of exemplary steps for using an auxiliary sealing device while replacing packing material.

### DETAILED DESCRIPTION OF THE DRAWINGS

Although this invention will be described in reference to what is known in the art as an “outlet device” for a continuous digester, it is understood that this invention is applicable to any shaft, either rotating or reciprocating or stationary, that penetrates the wall of a fluid containing vessel, either pressurized or unpressurized.

FIG. 1 illustrates the bottom section 10, of a Kamyr® continuous digester, as sold by Andritz Inc. of Glens Falls, N.Y. This vessel is used for the continuous chemical pulping of comminuted cellulosic fibrous material, for example, softwood chips. The comminuted cellulosic fibrous material enters the top of the vessel (not shown) and passes downward as it is treated with pulping chemicals at super-atmospheric pressure, typically 0.1 to 20 bar (0.1 to 300 psi), preferably 5 to 15 bar (70 to 220 psi), and at a temperature greater than 100° C., typically between 130° and 180° C.

After the pulping reaction is essentially completed, the pulped comminuted cellulosic fibrous material is discharged from the bottom of the digester 10, by means of a rotating bottom scraper device 11, mounted in the bottom head 12 of the digester. The outlet device 15 is typically driven by means of an electric motor 13, via a speed reducer 14. In this application, the outlet drive is typically driven at a speed between 1 and 20 rpm (revolutions per minute), preferably, 5 to 15 rpm, though in other applications the shaft rotational speed may be higher.

The bottom scraper 11 is supported within the pressurized vessel (digester) 10 by an outlet device 15 which includes bearings to support the weight and load on the rotating device and seals to prevent leakage of process fluids. The outlet device 15 allows the packing seals and other hardware of the outlet device to be more easily serviced. The outlet device houses a drive shaft 21 (shown in FIG. 2) that turns the bottom scraper 11 in the bottom of the digester. The drive shaft is powered by the electric motor 13 and speed reducer 14. The support assembly provides a coupling through which the drive shaft extends into the pressurized vessel of the digester.

FIG. 2 shows an elongated drive shaft 21, having a first end with a drive key 29, which engages the bottom scraper 11, shown in FIG. 1, and a second end having a second key 31, which engages a drive mechanism, for example, the gear reducer, 14, of FIG. 1. The first end of the shaft is within the pressure vessel, and the second end is outside the pressure vessel. The shaft 21 rotates about an axis. The outlet device 15 consists of an upper housing 22, which attaches to the bottom head 12 of the digester 10. The upper surfaces 52 of the upper housing of the outlet device are inside of the digester and exposed to the pressurized fluid in the pressurized vessel of the digester. A second housing 23 of the outlet device attaches to housing 22 via bolts or studs 32. This assembly of housings for the outlet device includes two roller bearing assemblies 24 and 25, and at least an upper packing or seal assembly 26 that forms an annular fluid-tight seal around the shaft 21. The shaft 21 may also include one or more liquid deflectors or “flingers” 28, which protect the bearing assemblies 24, 25 from leakage from above.

Prior to the present invention, should the packing assembly 26 require servicing or replacement, the pressurized slurry contents of the vessel 10 would be depressurized, evacuated, and, if toxic gases are present, ventilated prior to servicing. This slurry removal typically can take 22 to 28 hours before servicing of the bearings or seals is to begin. During this entire extended service period, the digester is shut down and not producing pulp. This prior art effort and the consequent loss in pulp production of a digester can cost as much as a million dollars (in year 2001 dollars) in lost pulp output.

The present invention permits the servicing and replacement of a packing assembly 26, without having to depressurize, evacuate, and, if toxic gases are present, ventilate the digester. To prevent leakage of digester fluid when the packing of the packing assembly is being serviced, an auxiliary sealing device 36 is clamped in place to seal the gap between the shaft 21 and the bearing wall surfaces of the housing 22 of the outlet device 15. The auxiliary sealing device 36 is within the pressurized vessel of the digester 10. This auxiliary sealing device is moved out of sealing position while the digester is in normal operation by, for example, elevating the auxiliary sealing device, e.g., a plate, above its sealing position. When the packing is to be serviced, the sealing device 36 is lowered (see arrows 21) into its sealing position and seals the shaft 21 to the outlet device such that digester fluid cannot leak past the sealing device. When clamped in place, the auxiliary sealing device 36 allows the packing 26 to be serviced by removal of the packing 26 and packing gland 46.

FIG. 3 is a partial cross section view showing in detail section B of FIG. 2. The shaft 21 is rotatably mounted in a cylindrical aperture in the upper housing 22. A rotating annular sleeve 40 keyed to the shaft provides a cylindrical surface that abuts the packing material 26 (shown as a column of “X”s in boxes in FIG. 3) in an annular gap 42 between the housing 22 and the shaft 21. The engagement between the packing material and sleeve form a fluid-tight seal that prevents fluid from the digester from flowing around the shaft 21 and out of the pressurized vessel of the digester around the shaft 21. The packing material, e.g., a rope-type fabric, elastomeric seal ring, or some form of “mechanical” sealing arrangement, is contained between a gland bushing 44 (at the upper end of the packing) and a packing gland follower 46, which is an annular flange at the bottom of the packing 26. To replace the packing material, the gland 46 is removed by sliding it downward along the shaft 21 in order to provide access to the packing material 26.

Before the packing material 26 is replaced, the auxiliary sealing device 36 is moved into sealing engagement between the shaft 21 and the upper housing 22. The sealing device comprises a movable plate 66 on which is mounted an annular sealing ring 50 that encircles the shaft 21. When the packing material is to be replaced, a sealing ring 50 of the sealing device 36 is clamped down between the shaft and to provide a seal between the sleeve 40 of the shaft and housing 22, so as to provide a fluid-tight seal across the cylindrical aperture between the housing 22 and sleeve 40 on the shaft 21. The sealing ring 50 includes, in cross-section, a triangular nose 54 and an upper sleeve 56. The nose has opposite sealing surfaces 58, 60 that engage, respectively tapered surface 62, on the sleeve 40, and tapered surface 64 on housing nose 65. The tapered annular surface 62 on the sleeve is at the top-outer edge of the sleeve 40 and matches the surface 58 of the nose 54 of the sealing ring. Similarly, the taper surface 64 of the housing nose 65 is at the inner-upper edge of cylindrical aperture 40 for the drive shaft.

The sealing ring 54 does not scrap, stick or otherwise harm the metal surfaces of the shaft, sleeve and housing. The sealing ring may be formed of a Teflon (TM) or other relatively soft material. The sealing ring may be attached to the annular top plate 66 of the auxiliary sealing device 36 by bolts 68 or other attachment devices. The plate has a lower and inner surface 70 that is shaped to mate with the sealing ring and hold the sealing ring in position. The upper surface of the plate is exposed to the pressures of the fluid in the pressurized vessel of the digester such that the pressure forces from the fluid are transferred through the plate and down onto the sealing ring (when the ring is in a sealing position). Thus, the fluid pressure in the digester assists in maintaining the fluid-tight seal of the sealing ring.

The top plate 66 and sealing ring 54 are mounted inside of the digester vessel. During normal digester operation, the plate is in an elevated position in which the sealing ring does not engage the tapered surfaces 62, 64 of the sleeve 40 or upper housing nose 65. Arrows 71 show the general up-down directional movement of the top-plate and sealing ring. This movement need be relatively small, as a purpose of the movement is to seat and unseat the sealing ring 54 against the tapered surfaces 62, 64 of the sleeve and housing.

The plate 66 may be mounted on pull-down rods 72 having screws that can be turned from outside of the digester vessel to move the plate up and out of sealing position, and down and into sealing position. A single pull-down rod is shown in FIG. 3 for illustrative purposes. In practice, there may be two or more pull-down rods arranged symmetrically around the shaft 21. The movement of the top plate 66 is provided by the pull-down rods 72 that are attached to the top plate and extend trough apertures 74 in the housing 22, which may include sealing rings 76 to prevent the leakage of digester fluid through the rod apertures. The bottom ends of the rods 72 may be threaded and engage a nut 78 that is rotated to move the rods (and hence the plate) up and down.

Gland passages 80 in the housing and near the top plate provide water passages that are used to direct water to flush the surfaces of the housing and shaft that engage the sealing ring. The water flush is applied just prior to moving the top plate and sealing ring into sealing position. In addition, the fluid pressure in these passages may be monitored by a pressure gauge 86 to confirm that a good seal exists, after the sealing plate is moved into its sealing position. A water source 82 may be coupled via piping 84 to the gland passages. Similarly, a water drain 88 may be connected to the piping are controlled by a valve 90.

FIGS. 4 and 5 are flow charts showing operation of the auxiliary sealing device. In operation, the packing material is replaced by moving the auxiliary sealing device 36 into a sealing position. Before the sealing device is moved into position, the outlet device, e.g., shaft 21, is stopped in step 1001, but not drained or depressurized. A check is made that there are no plugged water lines 80 associated with the pack box, in step 1002.

The seal water flow and water pressure to and from the bottom of the pack box are checked to confirm that the supply, return and drain seal water lines (e.g., piping 84) are not plugged, step 1003. A water flush is applied, step 1004, via the gland water passages 80 to clear the area around the sealing ring 54 and ensure that the contacting surfaces of the ring 58, 60, sleeve surface 62 and housing surface 64 are free of debris and ready to form a good fluid-tight seal.

While the flushing water continues to flow, the nuts 78 are turned to lower the rods 72 and lower the sealing plate 66 to bring the sealing ring 54 into sealing engagement with the sleeve surface 62 and housing surface 64, in step 1005. The turning of the nuts should be coordinated to ensure that the plate remains level. If the plate were to become cocked (off-level), then the mounting rods 72 could bind in the rod apertures 74 and the sealing ring 54 may not form a good seal. As the sealing ring engages the sleeve and housing, in step 1006, the water flush flow is reduced and ultimately shut-off as the sealing ring blocks the outlet of the gland water passage 80, step 1007. When the water flush flow is reduced to zero, the sealing ring has properly sealed the shaft and housing. If the water flow has not ceased, then the plate may be raised and re-lowered to reseat the sealing ring against the pack housing, in step 1008.

When the water flow stops, the torque on the nuts of the pull-down rods 70 should be at a predetermined level, such as 110 ft-lbs. If the torque reaches a high level, e.g., 110 ft-lbs. and the water flush flow continues, then the seal ring has not properly seated and rotation of the nuts 78 should be reversed to raise the plate 66, step 1009.

After the sealing ring is properly seated and the water flush flow is zero, then the water source 82 should be turned off and the water pressure drained at drain 88 to relieve pressure on the bottom of the sealing ring, step 1010. Once the water has been drained, the drain 88 is closed (step 1011) and a safety check is made to the pressure sensor 86 to confirm that there is no fluid pressure in the piping 84 coupled to the water flush gland passage 80, step 1012. If there is pressure in this passage, then the sealing ring is leaking and the sealing process should be restarted. The pressure on the sealing ring is then fully a downward pressure due to the force of the tension in the mounting rods 72 and the fluid pressure in the vessel of the digester.

If the pressure safety check confirms that there is no leakage of the sealing ring, then the packing gland follower 46 can be lowered and/or removed to provide access to the packing material 26, step 1013. The rings of the packing material 26 are removed one at a time. As each packing ring is removed, the pressure sensor 86 is monitored to confirm that there is no pressure in the water flush gland passage 80. Pressure in this passage 80 during the repacking process indicates that the sealing ring 54 is leaking and that the packing and gland 46 should immediately be reassembled. Assuming that all of the rings of the packing material are removed, then new packing rings 26 are installed, and the gland 46 is slid back up around the shaft 21/sleeve 40 to complete the repacking process, step 1014. Once the packing material has been replaced and repacked, the nuts 78 are turned to elevate the plate 66 and release the seal between the sealing ring and the tapered surfaces 62, 64 of the sleeve 40 and housing 22, step 1014. The plate and sealing ring are held in the elevated position as the digester is restarted, the shaft 21 begins to rotate and normal operation is resumed. During the entire repacking process, the digester remains pressurized with a fluid slurry.

The outlet device is not limited to application to continuous digesters. It may be applied to other pressure vessels in which there is a penetration of the shell of the vessel that can potentially result in leakage. The outlet device is particularly applicable to vessels, pressurized or unpressurized, which treat comminuted cellulosic fibrous material, for example, continuous digesters, batch digesters, impregnation vessels, or any other pre- or post-treatment vessels, including washing and bleaching vessels. The outlet device is also applicable to any pressurized or unpressurized vessel having devices for introducing material to a vessel, for example, conventional top separators, as sold by [Andritz-Ahlstrom Machinery], or any other form of agitator. The outlet device can also be used for mixers, degassing devices, or invasive instrumentation, for example, digester level indicators.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A shaft outlet assembly for a digester, comprising:
a rotatable shaft extending from the outlet assembly into a pressurized of the digester;
a pack box mounted on the digester and having packing around the shaft, and
a sealing ring mounted on a movable assembly inside of the pressure vessel, the sealing ring encircling the shaft, said movable assembly having a first position providing a nominal clearance between the sealing ring and shaft, and a second position at which the sealing ring is against the shaft and pack box to provide a substantially fluid-tight seal between said pack box and the shaft.

2. A shaft outlet assembly as in claim 1 wherein said shaft includes a sleeve having an annular end surface opposite to said sealing ring, and said annular surface engaging said sealing ring when the plate is moved with respect to the pressure vessel.

3. A shaft outlet assembly as in claim 2 wherein said shaft includes a tapered annular surface abutting said sealing ring when said movable assembly is in a second position.

4. A shaft outlet assembly as in claim 3 wherein said tapered surface is on a sleeve of the shaft.

5. A shaft outlet assembly as in claim 1 wherein said pack box includes a tapered annular surface to receive said sealing ring.

6. A shaft outlet assembly as in claim 5 wherein said annular ring on the ledge is serrated.

7. A shaft outlet assembly as in claim 1 wherein said pack box includes an annular surface opposite to said sealing ring, and said annular surface engages said sealing ring when the shaft is up-lifted.

8. A shaft outlet assembly as in claim 7 wherein said annular surface of the pack box includes at least one ridge that bites into said sealing ring when the shaft is up-lifted.

9. A shaft outlet assembly as in claim 1 wherein the digester receives a slurry of cellulosic fibrous material through said top separator.

10. A shaft outlet assembly as in claim 1 wherein said rotatable shaft extends vertically through said top separator and into said digester.

11. A shaft outlet assembly as in claim 1 wherein said sealing ring is formed of a soft sealing material.

12. A shaft outlet assembly as in claim 1 wherein said sealing ring is an annulus having a generally trapezoidal cross section.

13. A shaft outlet assembly as in claim 1 wherein said sealing ring has an upper surface and a lower surface, and said sealing ring upper surface is opposite to a lower annular surface of said pack box and said sealing ring lower surface is opposite to an annular ledge of said shaft.

14. A shaft outlet assembly as in claim 6 wherein said sealing ring further comprises an inner cylindrical surface mounted against an annular surface of said shaft, wherein said annular surface is adjacent said ledge of the shaft.

15. A shaft outlet assembly as in claim 1 wherein said shaft includes a shaft sleeve, and said sleeve includes a ledge supporting said sealing ring.

16. A method for servicing packing material in a shaft outlet assembly of a digester, wherein the assembly includes a plate with a sealing ring in a pressure vessel of the digester and said ring extends around a shaft extending into the pressure vessel of the digester and a pack box, said method comprising the steps of:
a. providing a fluid-tight seal between the shaft and pressure vessel with packing of the pack box;
b. in order to service the packing, moving the plate so as to press the sealing ring against the shaft and create a fluid-tight seal between the sealing ring and shaft;
c. refurbishing the packing material while maintaining a slurry in the digester under pressure using the seal formed by the sealing ring;
d. moving the shaft so as to move the sealing ring out of the fluid-tight seal with the shaft such that the packing material forms a seal between the pack box and shaft, and
e. rotating the shaft during operation of the digester, wherein the rotating shaft is sealed by the pack box and the sealing ring is separated from the pack box.

17. A method as in claim 16 further comprising the step of detecting a fluid pressure in the pack box before lifting the shaft.

18. A method as in claim 16 wherein the fluid pressure is monitored while the shaft is lifted.

19. A method as in claim 16 further comprising the step of abandoning steps (a) to (d) if the detected fluid pressure exceeds a predetermined pack fluid pressure.

20. A method as in claim 16 wherein said shaft is non-rotating during steps (a) to (d).
